(19) United States
(12) Patent Application Publication
(10) Pub. No.: US 2022/0401914 A1
(43) Pub. Date: Dec. 22, 2022

(54) BINDERLESS ADSORBENT FOR SEPARATION OF A GASEOUS STREAM

(71) Applicant: ZEOCHEM LLC, LOUISVILLE, KY (US)

(72) Inventors: Patrick Purcell, Louisville, KY (US); Kerry C. Weston, Coxs Creek, KY (US); R. Samuel Boorse, Louisville, KY (US)

(21) Appl. No.: 17/807,810

(22) Filed: Jun. 20, 2022

Related U.S. Application Data
(60) Provisional application No. 63/202,677, filed on Jun. 21, 2021.

(51) Int. Cl. B01J 20/18; B01J 20/12; B01J 20/28; B01J 20/30; C01B 13/02; B01D 53/02

(52) U.S. Cl. CPC B01J 20/186; B01J 20/12; B01J 20/28011; B01J 20/28085; B01J 20/3007; B01J 20/3078; B01J 20/3085; B01J 20/28016; C01B 13/027; B01D 53/02; C01B 2210/0018; B01D 2253/1085; B01D 2256/12

(57) ABSTRACT

A binderless zeolite adsorbent for separation of oxygen from a gaseous stream. The adsorbent is a blend of a lithium exchanged zeolite 13X, a lithium exchanged low silica zeolite X zeolite, and halloysite clay. Also disclosed is a process of making the binderless zeolite adsorbent. Further disclosed is a process for production of oxygen from a gaseous stream utilizing the binderless zeolite adsorbent.

### CROSS-REFERENCE TO RELATED APPLICATION

This Application claims priority to Provisional Application No. 63/202,677, filed on Jun. 21, 2021, the disclosure of which is incorporated by reference herein.

### BACKGROUND

### Field of the Invention

The invention is a binderless zeolite adsorbent, which is particularly useful for separation of a gaseous stream. This adsorbent has surprising physical characteristics, such as high tapped bulk density and crush strength, yet also exhibited high capacity, fast kinetics, excellent porosity, and significant pore structure improvements over the prior art.

In one embodiment, it is suitable for separation and concentration of oxygen by adsorption from a mixed gaseous stream, for example, a gaseous stream composed mainly of nitrogen and oxygen.

The invention also includes gas separation methods utilizing this adsorbent. These gas separation methods include, for example, but not limited to, pressure swing adsorption (PSA), vacuum pressure swing adsorption (VPSA), and temperature swing adsorption (TSA). These methods are particularly useful for separation and recovery of gases, such as oxygen, nitrogen, carbon dioxide, hydrogen, and other gaseous materials. Of these gases oxygen is important for medical uses. Oxygen production by PSA/VPSA methods involves selective adsorption of nitrogen gas from air onto an adsorbent, extraction of the remaining concentrated oxygen, and collection thereof as the end product.

The invention is also a process for the manufacture and production of a binderless zeolite adsorbent useful for gas separation, particularly the separation of oxygen from a gaseous stream.

### BACKGROUND OF THE INVENTION

The adsorbents of this invention are particularly useful for the adsorption and separation of gases. In one embodiment, the adsorbent compositions are used in processes for separating O₂ from mixtures containing N₂, O₂, and other gases by contacting the mixture with an adsorbent composition which selectively adsorbs the N₂ with one or more of the less strongly adsorbable components recovered as product.

Of particular interest is the use of these adsorbents in non-cryogenic gas separation processes for the production of O₂. For example, the separation of nitrogen from gas mixtures is the basis for several industrial adsorption processes, including the production of oxygen from air. In the cyclic production of oxygen from air, air is passed through an adsorbent bed having a preference for the adsorption of nitrogen molecules and leaving oxygen and argon (the less strongly adsorbable components) to be produced. The adsorbed nitrogen is then desorbed through a purging step, normally through a change in pressure, including vacuum, and/or through temperature changes to regenerate the adsorbent and the cycle is repeated. Such processes include pressure swing adsorption (PSA), temperature swing adsorption (TSA), vacuum swing adsorption (VSA) and vacuum pressure swing adsorption (VPSA) processes. Such processes are commonly used in commercial air separation operations, as well as in other industrial and medical processes.

The adsorbent used in these processes is an important factor in achieving an efficient, effective, and competitive process. The performance of the adsorbent is dependent on several factors, including the adsorption capacity for N₂, the selectivity between gases, which will impact the production yield, the adsorption kinetics, which will enable the adsorption cycle times to be optimized to improve the productivity of the process. The bulk density/crush strength/attrition rate of the agglomerated particles is also very important, particularly with respect to achieving a satisfactory adsorbent life in the adsorption process and system. Improvements in the pore structure, as expressed in median pore diameter, percent of small pores, and pore connectivity characteristics, are also important in the performance of the adsorbent. A particularly important parameter in evaluating pore structure is hysteresis, which is a factor useful in evaluating pore connectivity. Another important parameter useful for evaluating the adsorption rate of adsorbent is pore diffusivity (Dₚ), which is a measure of adsorption rate. These factors are generally dependent on the particle pore structure and overall pore architecture.

Conventional agglomerated adsorbents used for such adsorption processes are composed of zeolite powders (crystallite particles), including ion exchanged zeolite powders, depending on the process and binding agent. The binding agent is intended to ensure cohesion of the agglomerated particles, which are generally in the form of beads, pellets, and extrudates. Binding agents generally have no adsorbing property, and their only function is to give the agglomerated particles sufficient mechanical strength to withstand the rigors of deployment in packed bed adsorption systems and the vibrations and stresses to which they are subjected to during the adsorption process, such as pressurization and depressurization. The binding agent chosen and its concentration also impact the final pore structure of the agglomerated particles and the adsorbent's properties. It is known that the binding agent concentration should be as low as possible to reduce mass transfer resistances that can be negatively impacted from excess binder being present in the pores. Lower concentrations of binding agents can also increase overall adsorption capacity of the adsorbent. Certain binding agents, temporary binders, and other processing aids can also fill or otherwise partially plug the particle pores while other binding agents can have an adverse effect on the final pore structure, depending on the binding agents' carrier solvents.

One common method utilized to obtain agglomerated adsorbent particles with low binder concentrations, improved pore architectures and low mass transfer resistances is to use a caustic digestion method to prepare binderless adsorbents. Binderless adsorbents represent one approach to obtaining a low binder content, but at the expense of additional manufacturing steps and higher costs. The conventional approach for caustic digestion is to employ clay binding agents that can be converted to active adsorbent zeolitic material via the caustic digestion treatment. Several prior disclosures have claimed novel pore structures and demonstrated various levels of improvement to the adsorption rate properties from the use of binderless adsorbents.

Accordingly, it is desirable to provide a binderless adsorbent, method for production of the adsorbent, and methods to separate oxygen from a mixed air environment by processes such as pressure swing adsorption, temperature swing adsorption, vacuum swing adsorption and vacuum pressure swing adsorption. Desirable features and characteristics of the present inventions will become apparent from the subsequent detailed description of the inventions and the appended claims, taken in conjunction with the accompanying Examples and this background of the invention.

### BRIEF SUMMARY OF THE INVENTION

The invention includes a binderless adsorbent for separation of a gaseous stream, which adsorbent contains a blend of lithium exchanged zeolite 13X (“Li13X”), lithium exchanged low silica X zeolite (“LiLSX”), and residual halloysite clay. The quantity of the Li13X is from about 5 to about 20% of the adsorbent. The quantity of the LiLSX is from about 80% to about 90% of the adsorbent. The quantity of the halloysite clay is from about 0.1% to about 5.0% of the adsorbent.

This binderless absorbent exhibits high capacity for absorbing gases, fast kinetics, as measured by kinetic tests, and good pore structure characteristics while also exhibiting high crush strength, and high bulk density, equal to or greater than about 640 g/L, as measured according to DIN/ISO 787.

The adsorbent also exhibits a high hysteresis factor representing pore connectivity of at least about 0.6, as measured by standard Hg porosimetry data as described in U.S. Pat. No. 9,486,732 B2, and pore diffusivity (Dₚ) of at least about 5.0×10⁻⁶ as described in

$${k}_{i} = \frac{\text{?} {ε}_{p} ( \text{?} - {ε}_{b} ) D \text{?}}{{r}_{p}^{2}}$$

$$\text{?} \text{indicates text missing or illegible when filed}$$

and as disclosed in U.S. Pat. Nos. 6,500,234 B2, 6,790,260 B2, and 9,486,732 B2.

The adsorbent also has improved pore structure with median pore diameter of at least about 5 micron and a fraction of pores that are smaller than or equal to 0.1 micron less than about 6.0%.

The invention further includes a process of making an adsorbent for separation of a gaseous stream utilizing the following steps:

providing a low silica X zeolite,

mixing said low silica X zeolite with a halloysite clay to form a mixture, wherein said halloysite clay comprises from about 5% to about 20% of the mixture;

forming shaped products from said mixture;

calcining said shaped products;

caustically digesting said shaped products to convert at least about 70% of the halloysite clay into zeolite 13X; and

lithium exchanging the zeolite components in the shaped products to produce the adsorbent, wherein said adsorbent has a bulk density, measured according to DIN/ISO 787, of at least about 640 g/L, a hysteresis factor greater than or equal to 0.6, as measured by Hg porosimetry, as described, in U.S. Pat. No. 9,486,732 B2, and high pore diffusivity (Dₚ) greater than or equal to 5.0×10⁻⁶ m²/s.

Said invention also includes a process for the use of the adsorbent for separation of gaseous materials, particularly oxygen from a gas stream.

### BRIEF SUMMARY OF THE EMBODIMENT OF THE INVENTION

Disclosed is an adsorbent particularly useful for separation by pressure swing adsorption (PSA), vapor pressure swing adsorption (VPSA), or temperature swing adsorption (TSA) of a gaseous stream, particularly for separation of O₂ from air.

One adsorbent particularly useful for this process is composed of X or Y zeolite crystals, particularly X zeolite. Preferred are one or more type zeolite X which incorporate cations, such as Li, Ca, K, Na, Ag, and mixtures thereof, particularly Li, wherein one embodiment is a zeolite X containing Li cations. The SiO₂/Al₂O₃ ratio is preferably less than 15, in one embodiment less than 5, and in another embodiment less than or equal to 2.5. A particularly alternative embodiment has a SiO₂/Al₂O₃ ratio of from about 1.9 to about 2.3. (For purposes of this disclosure, zeolite X with a silica to alumina ratio less than or equal to 2.3 is referred to as “low silica X zeolite”, “LSX zeolite” or “LSX”. Zeolite X with a ratio of silica to alumina greater than 2.3 to about 2.6 is referred to as “13X zeolite”, “zeolite 13X” or “13X”. For purposes of this disclosure, lithium-exchanged zeolites of 13X are referred to as “lithium exchanged zeolite 13X”, “Li13X”, or “Li13X zeolite” and lithium exchanged low silica zeolite X are referred to as “lithium exchanged low silica X zeolite”, “LiLSX”, “LiX” or “zeolite LiX”.)

A limitation on utilization of zeolite crystals is their extremely fine particle size. Naturally formed agglomerates of these crystals break apart easily. Because pressure drop through a bed of these zeolite crystals is prohibitively high, they cannot generally be used alone in a fixed bed for many applications.

Accordingly, it has been useful to agglomerate these crystals with a binder material to provide an agglomerated mass, which exhibits reduced pressure drop.

Various clay materials, such as kaolin or attapulgite clay, have been commonly used as the binder material with these zeolite crystals. In addition, silicone-derived binding agents have been utilized, for example as disclosed in U.S. Pat. Nos. 9,486,732 B2 and 9,050,582 B2.

Notwithstanding the usefulness of such binder materials, it has been discovered that the binding agents used in these agglomerated material reduce the overall effectiveness of the zeolite product for the adsorption process.

To overcome this problem, binderless adsorbent materials have been produced, wherein the clay binder material is converted to a zeolite.

In order to produce this binderless material, it is necessary to convert the binder to a useful zeolite blend material. Prior art binderless LiX adsorbents have generally utilized kaolin clay as the binder for formation of binderless adsorbents because kaolin clay can be converted to a low silica LiX zeolitic material using caustic digestion processes.

It has been surprisingly discovered that improved properties can be produced in an adsorbent when utilizing halloysite clay as the binder material for a low silica LiX zeolite. In one embodiment the halloysite clay has a tubular shape with a length from about 0.5-2.0 micron and a diameter of about 50-100 nm.

In one embodiment the method for manufacturing an agglomerated binderless adsorbent composition is as follows:
a. preparing a mixture containing one or more active zeolite materials and a halloysite clay binding agent,
b. mixing the zeolite material and the halloysite clay material with water and forming agglomerated adsorbent particles,
c. drying the agglomerated adsorbent particles,
d. calcining the dried agglomerated adsorbent particles to form calcined adsorbent particles,
e. caustically treating the calcined adsorbent particles to convert at least a portion of the halloysite clay binder agent into a 13X zeolite;
f. treating the calcined adsorbent particles with a metal salt solution to ion-exchange at least a portion of the cations present to ion-exchanged agglomerated adsorbent particles, and
g. drying and activating the ion-exchanged particles by heating the ion-exchanged agglomerated particles to form the agglomerated adsorbent composition.

In one process for production of the binderless adsorbent, a LSX zeolite is provided which comprises from about 80 to about 95% of an overall blend of materials. The LSX zeolite is mixed with a halloysite clay in an amount from about 5 to about 20% of the overall blend, and the mixed components are kneaded together to form a uniform blended product. Water is preferably utilized during the formation of the blended product. The quantity of water that is added, and other characteristics of the mixing step, depend on the quantity of the materials utilized therein.

The blended product is kneaded, granulated, and shaped into a preferred shaped product. It can be formed into beads, extrudates and/or spray dried microspheres and in one embodiment, it is formed into beads.

The resulting product is then dried at a temperature from about 100° C. to 400° C. After drying it is calcined at a temperature from about 500 to about 700° C. to produce a shaped LSX/halloysite clay blended product.

The LSX/halloysite clay blended product is then treated with a caustic solution that converts a significant portion of the halloysite clay into a zeolite 13X. In one embodiment, from about 60 to about 95% or more of the halloysite clay is converted into a zeolite 13X. The process of caustically digesting the halloysite clay material occurs at a temperature of about 80° C. utilizing a caustic solution. In one embodiment the caustic solution contains primarily sodium hydroxide and potassium hydroxide. In a further embodiment the caustic solution is substantially sodium hydroxide. Utilization of substantially sodium hydroxide for the caustic treatment results in production of substantially more of the zeolite 13X from the halloysite clay. Other combinations of hydroxides and other materials can be utilized to modify the final composition of the adsorbent.

There is no limitation on the exact method of contact of the blended product with the caustic solution. In one method the blended product is packed into a fixed bed column and the caustic solution is circulated throughout.

Following this conversion process, the product is lithium-exchanged at least about 90%, in one embodiment at least about 95%, and in another embodiment at least about 98% to produce the final adsorbent. The final adsorbent includes from about 80 to about 90% LiLSX and from about 5% to about 20% of Li13X with the remaining quantity being residual halloysite clay in an amount from about 0.1 to about 5%. Also present in the final composition of the adsorbent after the conversion may be oxides of any of the following elements alone or in combination: Al, Si, Ba, Li, Na, K, Mg, Ca, Fe, Ti, Y and Zr, along with other residual components.

In the prior art the preferred adsorbent preferably utilized a kaolin clay as the binder that, when converted into a zeolite, has the same composition as that of the primary zeolite that is utilized for the desired adsorption process. For example, caustic digestion of a kaolin clay, generally produces a low silica LiX zeolite. Applicant has discovered that a surprisingly useful adsorbent can be produced that contains both LiLSX zeolite and Li13X zeolite along with a quantity of residual halloysite clay.

The adsorbent produced by this process has enhanced physical characteristics over those of prior art adsorbents.

In one embodiment the adsorbent exhibits tapped bulk density of at least about 640 g/L measured by DIN/ISO 787 and crush strength of at least about 8 N/mm.

Notwithstanding these physical characteristics, the adsorbent surprisingly also exhibits good pore structure, as measured by median pore diameter, a low fraction of pores that are less than or equal to 0.1 micron, and a high hysteresis factor, representing pore connectivity. The median pore diameter in one embodiment is greater than or equal to 5 microns and the fraction of the pores less than or equal to 0.1 micron is less than about 10%, and in one embodiment less than about 6%. The adsorbent also surprisingly exhibits a hysteresis factor greater than or equal to about 0.6, when measured by standard Hg porosimetry data, as described, for example, in U.S. Pat. No. 9,486,732 B2.

Typically, materials which have high densities and high crush strength exhibit lower porosities and likely slower nitrogen uptake rate. Surprisingly, the disclosed adsorbent composition has high strength and high crush strength as well as low porosity and has a surprisingly fast nitrogen uptake rate which can be attributed to the characteristics of the pore structure.

As a result of these characteristics of the disclosed adsorbent composition, it exhibits high adsorption rates as measured by pore diffusivity (Dₚ) greater than 5.0×10⁻⁶ m²/s. Higher values for pore diffusivity (Dₚ) indicate that the diffusion of materials within the particles is surprisingly fast. This high diffusivity (Dₚ) is surprising, especially considering the physical characteristics of the adsorbent particles. This disclosure of pore diffusivity (Dₚ) is determined based on nitrogen pore diffusivity as described in U.S. Pat. Nos. 6,500,234 B2, 6,790,260 B2, and 9,486,732 B2.

### EXAMPLES

### Inventive Example 1

A low silica zeolite X (2.0 silica/alumina ratio) is mixed with a halloysite clay in a ratio of about 85/15 zeolite to clay. This mixture is then formed into spheres and calcined. These calcined particles are then introduced to a hot (˜90 C) sodium hydroxide solution for several hours to convert the clay into 13X zeolite. The particles are then washed with water to remove excess caustic, and then the particles undergo a lithium ion exchange to at least about 95%. The quantity of the lithium exchanged low silica zeolite X is 85%, the quantity of the lithium exchanged zeolite 13X is 12%, and the quantity of the residual halloysite clay is 3%.

### Comparative Sample 1 (C-1)

A shaped adsorbent containing lithium exchanged low silica X zeolite with an attapulgite binder, as described in columns 3-8 of U.S. Pat. No. 7,300,899.

### Comparative Sample 2 (C-2)

A binderless adsorbent, as described in columns 8 and 9 of U.S. Pat. No. 6,425,940 B1.

### Comparative Sample 3 (C-3)

A shaped adsorbent containing lithium exchanged low silica X zeolite with a silica-based binder, as described in example 2 of U.S. Pat. No. 9,486,732 B2.

### Comparative Sample 4 (C-4)

A binderless shaped adsorbent obtained from Tosoh, which contains LiLSX with a commercial name of NSA-700.

### Comparative Sample 5 (C-5)

A binderless shaped adsorbent obtained from Hanchang, which contains LiLSX.

In the following Table 1, characteristics of Inventive Example 1 are compared with adsorbents of Comparative Samples C-1, C-2, C-3, C-4, and C-5.

TABLE 1

| | Physical Parameters of Inventive Sample I-1 in comparison | | | | | |
|---|---|---|---|---|---|---|
| | with Comparative Samples C-1, C-2, C-3, C-4, and C-5 | | | | | |
| | Median | Tapped | | Pore | | |
| | Pore | Bulk | Crushing | Hysteresis | Pore | Small |
| Sample | Diameter¹ | Density² | Strength³ | Factor⁴ | Diffusivity⁵ | Pore %⁶ |
| I-1 | 0.6 | 660 | 11 | 0.7 | 6.46E−6 | 4.7 |
| C-1 | 0.3 | 610 | 5.6 | 0.4 | 4.02E−6 | 22.0 |
| C-2 | 0.9 | | | 0.2 | | 9.1 |
| C-3 | 0.5 | 620 | 4.8 | 0.8 | 4.99E−6 | 6.4 |
| C-4 | 0.5 | 680 | 6.7 | 0.4 | 3.35E−6 | 11.8 |
| C-5 | 0.4 | 611 | 5.1 | 0.6 | 4.79E−6 | 12.6 |

¹microns
²g/L
³N/mm
⁴See description of pore hysteresis factor in U.S. Pat. No. 9,486,732 B2
⁵Pore diffusivity(Dₚ), as described in U.S. Pat. No. 6,500,234 B2 and U.S. Pat. No. 6,790,260 B2.
⁶pores less than 0.1 micron per mercury porosimetry analysis.

From the data in Table 1, it is evident that the inventive adsorbent composition containing a combination of LiX and Li13X with residual halloysite clay has the best combination of both physical characteristics and pore structure, including median pore diameter, lower percentage of pores that are less than 0.1 μm, improved hysteresis factor and higher pore diffusivity. Notwithstanding these improved characteristics, the inventive composition also contained a higher tapped bulk density and greater crushing strength than the comparative examples.

While a conventional composition with high density and crush strength traditionally meant a composition with reduced mass transfer or pore diffusivity (Dₚ), surprisingly, the inventive composition exhibited higher pore diffusivity (Dₚ) than the comparative compositions. The inventive composition also showed a diffusion rate within the particles that was surprisingly fast, even though the composition had high density and crush strength. Nitrogen uptake rates for the inventive composition was also surprisingly fast in comparison to the other compositions.

The inventive binderless adsorbent is particularly useful for separation of gaseous streams, such as for recovery of concentrated oxygen gas through selective adsorption of nitrogen in air. When oxygen in air is concentrated using PSA, VPSA, or TSA methods, the operation involves a series of steps including an adsorption step, in which a packed layer of a binderless zeolitic material is contacted with air for the selective adsorption of nitrogen. Concentrated oxygen is then collected from an outlet of the packed bed. Further processing of the gaseous material is conventional.

The adsorbent of this invention is particularly effective for air separation by the PSA/VPSA/TSA method. When air is separated by the PSA/VPSA/TSA method, the amount and yield of concentrated oxygen gas is high and the adsorbent exhibits good physical characteristics for long life.

The foregoing detailed description is provided for understanding and does not provide any limitation on the scope of the claims. Modification to the invention will be obvious to those skilled in the art upon a review of the disclosure without departing from the scope of the impended claims.

1. A binderless adsorbent for separation of a gaseous stream comprising
a blend of a lithium exchanged zeolite 13X (Li13X), a lithium exchanged low silica X zeolite (LiLSX), and halloysite clay,
wherein the Li13X comprises from about 5 to about 20% of the adsorbent,
wherein the LiLSX comprises from an 80 to about 90% of the adsorbent, and
wherein the halloysite clay comprises from about 0.1% to 5.0% of the adsorbent, and
wherein the adsorbent has a bulk density of at least about 640 g/L, as measured according to DIN/ISO 787.

2. The binderless adsorbent for separation of a gaseous stream of claim 1 wherein the adsorbent exhibits a median pore diameter greater than or equal to 5 microns, a percentage of pores less than 0.1 micron lower than 6.0 percent, and a pore diffusivity (Dᵣ), based on nitrogen pore diffusivity, as described in U.S. Pat. No. 6,500,234 B2 and 6,790,260 B2, greater than 5.0×10⁻⁶ m²/s.

3. The binderless adsorbent for separation of a gaseous stream of claim 1 wherein the adsorbent exhibits a crush strength greater than 8 N/mm.

4. The binderless adsorbent of claim 1 wherein the adsorbent has a hysteresis factor of at least about 0.6, as measured by the Hg porosimetry method described in U.S. Pat. No. 9,486,732 B2.

5. The binderless adsorbent of claim 1 wherein the adsorbent has a median pore diameter greater than or equal to 5 microns and a hysteresis factor of at least about 0.6, as measured by the Hg porosimetry method described in U.S. Pat. No. 9,486,732 B2.

6. A process of making an adsorbent for separation of a gaseous stream comprising the following steps:
providing a low silica X zeolite;
mixing said zeolite with a halloysite clay to form a mixture, wherein said halloysite clay comprises from about 5% to about 20% of the mixture;
forming shaped products from said mixture;
calcining said shaped products;
caustically treating said calcined shaped products to convert at least a portion of said halloysite clay to a 13X zeolite; and
lithium exchanging the LSX and 13X zeolite of said shaped products to produce the adsorbent.

7. The binderless adsorbent of claim 6 wherein the halloysite clay has a tubular shape with a length from about 0.5-2.0 micron and a diameter of about 50-100 nm.

8. The process of claim 6 wherein halloysite clay comprises from about 0.1 to about 5% of the adsorbent.

9. The process of claim 6 wherein a hydroxide is used for caustically treating the shaped products comprising sodium hydroxide and potassium hydroxide.

10. The process of claim 6 wherein a hydroxide is used for caustically treating the shaped products comprises substantially sodium hydroxide.

11. The process of claim 6 wherein the adsorbent exhibits a median pore diameter greater than or equal to 5 microns, a percentage of pores less than 0.1 micron lower than 6.0 percent, and a pore diffusivity (Dₚ), based on nitrogen pore diffusivity as described in U.S. Pat. Nos. 6,500,234 B2 and 6,790,260, greater than 5.0×10⁻⁶ m²/s.

12. The process of claim 6 wherein the adsorbent exhibits a crush strength greater than 8 N/mm.

13. The process of claim 6 wherein from about 60 to about 95% of the halloysite clay is converted into zeolite 13X.

14. The process of claim 6 wherein the adsorbent has a crush strength greater than 8 N/mm, a median pore diameter greater than or equal to 5 microns, and a hysteresis factor of at least about 0.6, as measured by the Hg porosimetry method described in U.S. Pat. No. 9,486,732 B2.

15. The process of claim 6 wherein the low silica X zeolite and the 13X zeolite are lithium exchanged at least about 95%.

16. A process for the production of concentrated oxygen from a gaseous stream utilizing the binderless adsorbent of claim 1.
